(19) United States
(12) Patent Application Publication
(10) Pub. No.: US 2005/0060258 A1
(43) Pub. Date: Mar. 17, 2005

(54) Customer funds transfer system and method

(76) Inventor: Timothy Murphy, County Cork (IE)

Correspondence Address: JACOBSON HOLMAN PLLC, 400 SEVENTH STREET N.W., SUITE 600, WASHINGTON, DC, 20004, US

(21) Appl. No.: 10/975,372

(22) Filed: Oct. 29, 2004

Related U.S. Application Data
(63) Continuation of application No. PCT/IE02/00057, filed on Apr. 30, 2002.

(51) Int. Cl. G06F 17/60

(52) U.S. Cl. 705/39; 705/42

(57) ABSTRACT

The invention is a customer funds transfer system (1) and method for use in a public communications network (2), interconnecting a host system computer (5), a series of merchant computers or terminals (3), merchant financial institutions (10) associated with each merchant computer (3) and, in some instances, a customer financial institution computer (10). In the system a customer has a savingscard which, when they present it to a merchant, the merchant in the merchant terminal or merchant computer (3) transfers some funds to the host system computer (5) for crediting to an account for the customer. The system allows relatively small sums of money to be saved, either by way of discount from a merchant, change from a cash transaction, or the deliberate payment, by a customer through the merchant, of a sum of money. Then the merchant transfers that sum to the host system computer (5) where it is credited to a customer account maintained by the host system computer (5). At a certain stage, the money is either transferred directly to the customer or to the customer financial institution (10).

The present invention relates to a customer funds transfer method and system for use in a public communications network interconnecting a host system computer, including a central processor, a merchant database and a customer database, each merchant and customer having a unique ID stored in the respective database; a merchant financial institution computer associated with a merchant computer for handling the merchant financial transaction with the customer; and a customer system account, associated with the host computer for each customer.

There are many savings products on the market, sold by financial institutions, which saving products encompass a wide variety of offerings. Some of the savings products are short term, others are medium term or long term. Typically, short term savings products are some deposit account based product. All of the latter products require that a consumer saves on a regular basis, usually by way of instalment. Indeed, many such savings accounts are by way of regular monthly instalments, often credited from a person's salary and transferred to the particular savings account. It is always possible with most savings accounts, except those that require a regular payment of a specified amount, to lodge additional funds in the account. A very small minority of the population save in this way. Indeed, people who are used to saving often have deposit accounts into which they lodge sums of money at irregular time intervals. However, for the vast majority of the population, these deposit accounts are inappropriate. Most people will not go to the trouble of lodging money to an account but will simply spend the money. Essentially, lodging small sums such as a few euros or even cents is impractical. Further, many people would be quite willing to save, what could be said to be, their small change. Indeed, some people have, in their homes, jars, bottles or other containers, into which they put, each night, all the small change they have gathered throughout the day. How they dispose of that money varies from person to person. Some of them use it at contributions to charity. Others simply gather it up over a period of time and then go to a bank and lodge the money. For many people, getting relatively small amounts of change from merchants, after a transaction has been completed, is a nuisance.

Ideally, there should be, for the consumer, an easier way of saving. One would almost suggest that such a way should be painless, seamless and one which does not cause the consumer any difficulty whatsoever. Ideally, the saving should be almost unconscious or automatic.

Further, for most governments, there is a serious need to promote a saving ethos within the population. It is a major problem in many economies that the consumer is spending more than they are earning or if not, are not saving a sufficient sum to protect and support themselves in times of economic adversity. This problem is exacerbated by the use of credit cards and cheap credit generally, in times of prosperity.

The present invention is directed towards overcoming some of these problems and providing a method and system to allow consumers and customers of merchants save in a relatively easy way.

Because, in the present invention, the saving will be carried out mainly between the consumer acting as a customer of a merchant, the term “customer” is used for the person carrying out the saving.

### STATEMENTS OF INVENTION

According to the invention, there is provided a customer funds transfer method for use in a public communications network interconnecting a host system computer, including a central processor, a merchant database and a customer database, each merchant and customer having a unique ID stored in the respective databases; a merchant financial institution computer associated with a merchant computer for handling the merchants financial transaction with the customer; and a customer system account, associated with the host computer, for each customer, the method comprising, on a trade taking place between the merchant and the customer, the steps of the merchant computer sends a transaction message to the host system computer detailing an amount of money, namely, a system payment forming part or all of a financial transaction with the merchant by the customer which is to be credited to the customer, together with the merchant and customer IDs;
the merchant computer sends a similar message to the merchant financial institution computer;
the merchant financial institution collects the system payment and sends it to the host system computer; and
the host system computer credits the customer system account.

The advantage of this is that it is relatively seamless for the customer. The customer can add relatively small sums of money by way of savings, without having to conduct an elaborate lodgement or other savings system.

The present invention overcomes in an elegant and simple manner the technical problem of allowing a person save relatively small sums of money with effectively minimal transaction costs. The funds are collected seamlessly, almost certainly in conjunction with another transaction and will thus cost virtually nothing to collect Indeed, the aggregate value of a large number of small customer system accounts, which will be effectively available to the operator of the host system computer, may be substantial and thus of considerable commercial benefit to the operator.

When the customer has a separate account established with a customer financial institution and a predetermined triggering event occurs, the host system computer:
sends funds to the financial institution for the customer's separate account; and

Needless to say, when a predetermined triggering event occurs, the host system computer may send funds to the customer and debit the customer system account.

Generally, funds are not transferred to the customer until the amount credited to the customer system account exceeds a preset threshold.

In another embodiment, the host system computer sends a message to the customer detailing the amount credited to the customer account on a triggering event occurring. The predetermined triggering event may be one or more of:
the amount credited to the customer system account exceeds a preset level;
a preset time has elapsed since the last time the necessary action, arising out of the triggering event, was carried out;
the number of system payments exceeds a preset number; and
the customer requests the necessary action.

In another method according to the invention, the system payment comprises a discount to be determined by the host system computer and in which the system payment amount given in the transaction message is not a specific amount but requests the system computer to confirm the discount as the system payment, the additional steps are carried out of:
the system computer calculates the discount;
the discount is downloaded as a system payment to the merchant computer; and
the merchant computer downloads the calculated system payment to the merchant financial institution.

In a still further embodiment, the system payment comprises a discount determined by the merchant computer and such a discount may be determined by one or more of:
the time of day the transaction occurs;
the day of the week the transaction occurs;
the total monetary value of the transaction; and
the aggregate amount of the current and other transactions carried out within a predetermined time prior to the current transaction.

It will allow merchants to market their goods and services with what would in other circumstances be relatively minor and unappreciated discounts and loyalty bonuses. As the system becomes more widely used by outlets the more attractive it will becomes to the consumer who may be relatively unappreciative of a small discount on a purchase of low monetary value, but will quickly appreciate that the aggregate value of the small purchases he or she makes over a week or a month can be significant and thus any discount earned is to be cherished.

Further, the invention provides a customer funds transfer system for delivering funds to a customer system account from a merchant using a public communications network comprising:
a merchant computer;
a host system computer having a central processing unit (CPU), a merchant database storing a unique ID for the merchant computer, and a customer database storing a unique ID for each customer system account;
a merchant financial institution computer associated with a merchant computer for handling the merchant's financial transaction with the customer;
message means in the merchant computer to send a transaction message to the host system computer detailing an amount of money, namely, a system payment forming part or all of a financial transaction with the merchant by the customer which is to be credited to the customer, together with the merchant and customer IDs and to send a similar message to the merchant financial institution computer;
collection means in the merchant financial institution computer to collect the system payment and send it to the host system computer; and
credit means in the host system computer credit the customer system account with the system payment.

In this latter system, very often, the host system computer has means to determine a triggering event and on the triggering event occurring, causing the funds in the customer system account to be transferred to a customer financial institution computer.

Further, the invention provides a host system computer programmed to operate in a public communications network interconnecting the host system computer, including a central processor, a merchant database, a customer database, each merchant and customer having a unique ID stored in the respective databases; a remote merchant financial institution computer associated with a remote merchant computer for handling the merchants financial transaction with the customer; and a customer system account, associated with the host computer, for each customer and to carry out a method comprising, on a trade taking place between the merchant and the customer, the method as described above, in conjunction with the remote merchant computer.

Further, the invention provides a merchant computer programmed to operate in a public communications network interconnecting a remote host system computer, including a central processor, a merchant database and a customer database, the merchant and customer having a unique ID stored in the respective databases; a remote merchant financial institution computer associated with the merchant computer for handling the merchants financial transaction with the customer; and a customer system account, associated with the host computer, for each customer and to carry out a method comprising, on a trade taking place between the merchant and the customer, the method as described above, in conjunction with the remote systems computer.

Further, the invention provides a computer program comprising program instructions to perform the steps of the method as described above.

Further, the invention provides a computer program comprising program instructions to perform the steps carried out by the merchant computer of the method as described above.

Further, the invention provides a computer program comprising program instructions to perform the steps of the method as described above, carried out by the system computer.

Further, the invention provides a computer program as described above which is embodied on a record medium, stored in a computer memory, embodied in a read-only memory or when carried on an electrical carrier signal.

### DETAILED DESCRIPTION OF THE INVENTION

The invention will be more clearly understood from the following description of one embodiment thereof, given by way of example only, with reference to the accompanying drawings, in which:

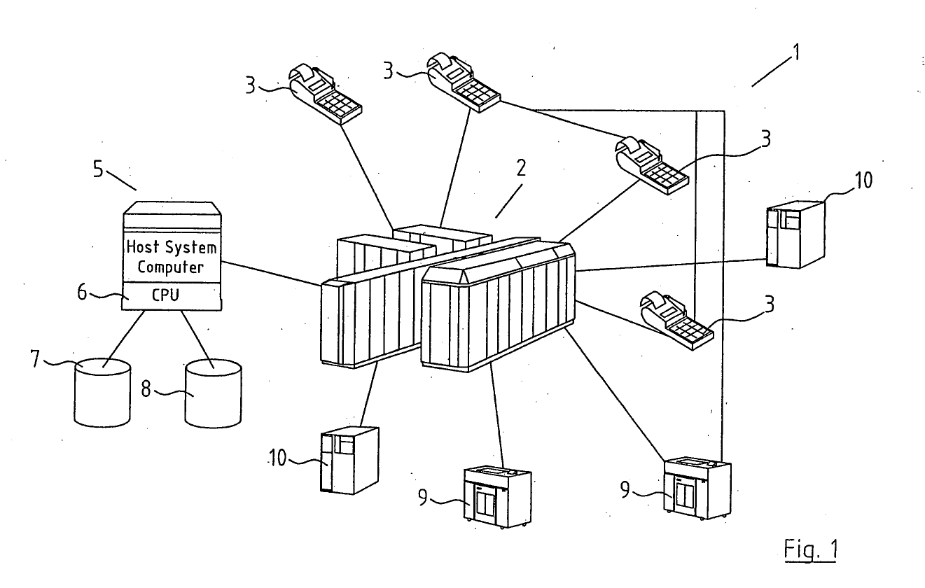

FIG. 1 is a diagrammatic view of various computers and a communications system used in accordance with the invention;

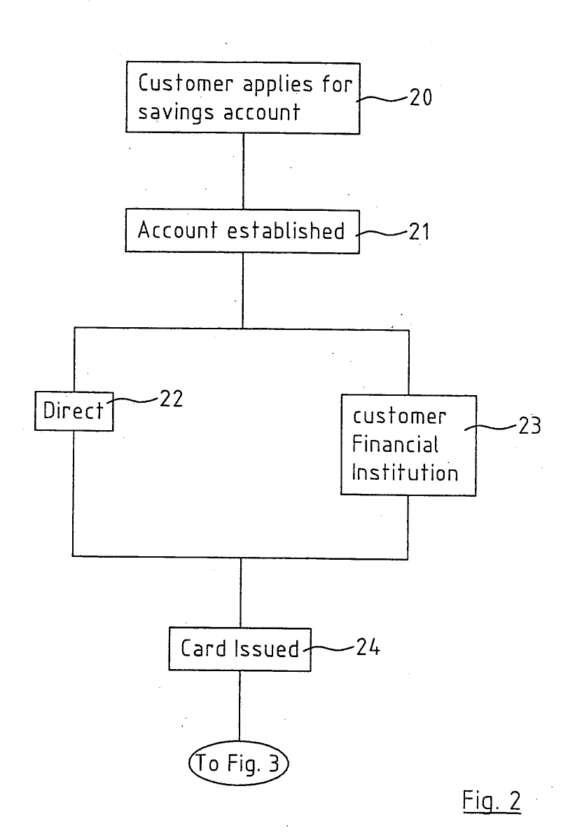

FIG. 2 is a flowchart showing the setting up of an account; and

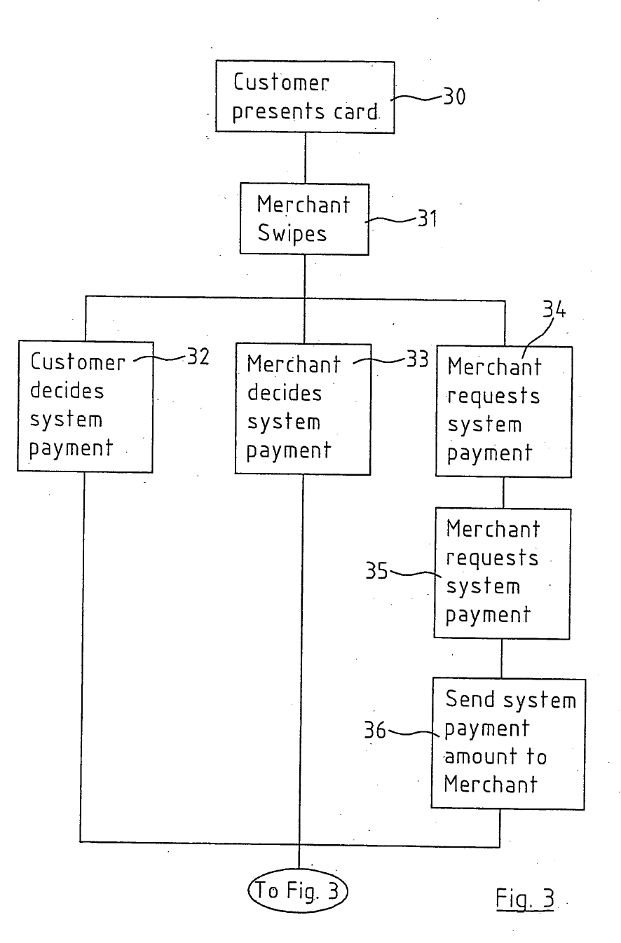

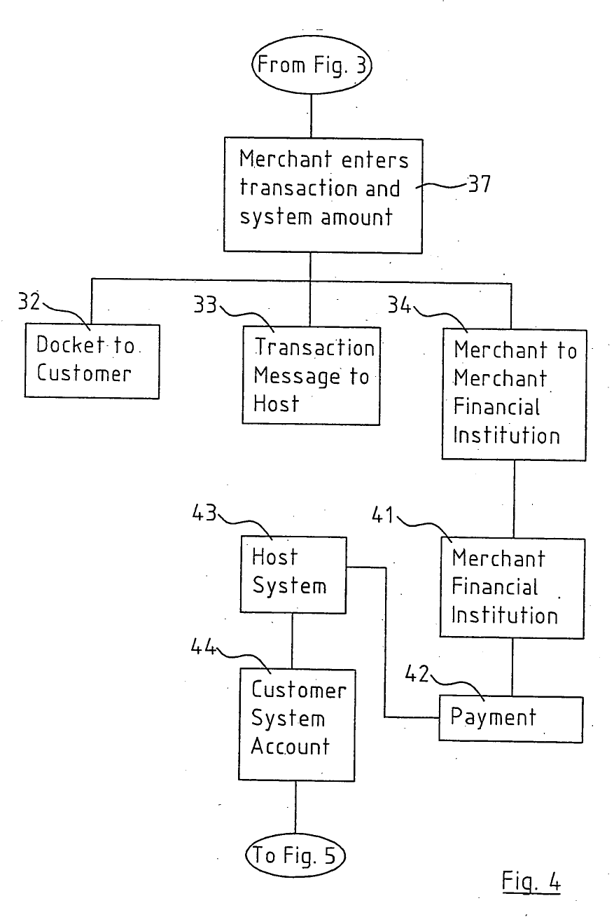

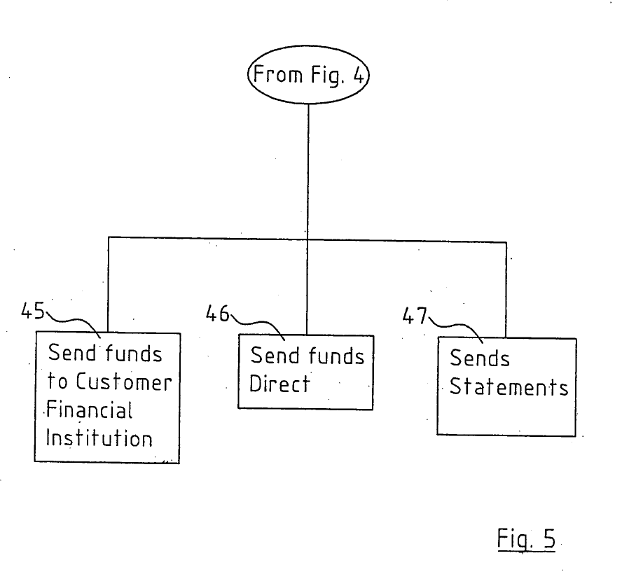

FIGS. 3 to 5 are a flowchart showing one operation of the invention.

Referring to the drawings and initially to FIG. 1, there is illustrated a customer funds transfer system, indicated generally by the reference numeral 1, all connected to a public communications network 2, to which are connected, either by wire or wireless, a plurality of merchant terminals or merchant computers 3. Also connected in the customer funds transfer system 1 is a host system computer, indicated generally by the reference numeral 5, having a central processing unit (CPU) 6, a customer database 7 and a merchant database 8, all forming part of the system. There is also provided merchant financial institution computers 9 and customer financial institution computers 10. It will be appreciated that the one merchant financial institution computer may serve a multiplicity of merchants and that similarly, the one customer financial institution may serve a multiplicity of customers.

Very often, the merchant, if a small business, may only operate a terminal connected to various financial institutions such as AMEX, VISA and other debit card operators. Larger merchants will have quite sophisticated computer systems interconnecting many terminals and computers and thus the term “computer” covers both.

Referring now to FIG. 2, there is illustrated the set-up of the savings system according to the invention. In step 20, a customer applies for a savings account or customer systems account and in step 21, the account is established, either as a customer systems account which will have a direct payment, as shown in step 22, or the account is established so that, in step 23, there is entered details of a customer financial institution to whom any funds arising out of the savings of the customer funds transfer method or savings system, will be transferred. Then, in step 24, a card is issued to the customer. The card will have the same number and formatting of numerals as any credit or debit card with the same scheme for card issuer, card holder or customer, checksum, and so on, used. The card will have a normal magnetic swipe and can be used in exactly the same way as any debit card.

Referring now to FIGS. 3 to 5, on a transaction taking place, in step 30, the customer presents the savings card to the merchant. In step 31, the merchant swipes the savings card in exactly the same way as he or she would swipe any credit card or debit card. To decide a system payment, various different operations take place. In step 32, the customer decides the system payment. For example, the customer might have presented a debit card to the merchant or might simply be paying for some goods or services by normal currency. The customer might have indicated to the merchant that the merchant was to take an extra [symbol] 15 or simply credit the change out of the note tendered as a system payment. Alternatively, in step 33, the merchant might decide the system payment, having regard to some special offer, loyalty scheme, discount, or the like, that the merchant operated. Alternatively, in step 34, the merchant might have agreed with the operators of the host system computer that, depending on certain circumstances, various discounts would be afforded to the person or customer proffering the savings card. In this case, the merchant would then request the amount of the systems payment from the host system computer in step 34. In step 35, the host system computer will then calculate the discount required and then in step 36, this discount is sent as a system payment to the merchant. Needless to say, step 32 and one or other of steps 33 and 34 may be carried out. In step 37, the merchant enters the transaction and system payment amount into the sales terminal or merchant computer. Then, in step 38, a docket is given to the customer and in step 39, a transaction message is sent to the host computer detailing the transaction and the system payment amount. Where the payment received by the merchant is not in currency, the merchant computer sends to the merchant financial institution computer, the details of the transaction and the system amount, obviously, in all case, including both the merchant and customer I.D. Even where the transaction is a cash payment, it will, in most cases, be more convenient for the merchant to have the merchant financial institution computer handle the payment. The merchant financial institution, in step 41, obtains the necessary funds and then in step 42, sends payment to the host system computer which receives it in step 43. Where the payment has been received by the merchant in cash, the merchant financial institution computer on again receiving the cash from the merchant or by prior agreement with the merchant, automatically sends the payment to the host system computer. So, effectively, as far as the invention is concerned, there is little difference between the manner in which the host system computer receives the funds.

In step 44, the host system computer credits the customer system account. Then, either in step 45, simultaneously at some time period later, the host system computer sends the funds to the customer financial institution or in step 46, sends the funds directly to the customer and further, in step 47, at various time intervals, the host system computer sends statements, debits and credits entered into the customers account, to the customer.

The manner in which the invention can be carried out is obviously by way of computers programmed to carry out some or all of the steps of the method described herein. It is envisaged, for example, that it is possible that the host system computer for carrying out many of the steps according to the invention, will be sited in a location remote from the merchant computer. They might both be in the one jurisdiction, however, it is envisaged that they could be in different jurisdictions. Therefore, this application is directed to covering both the invention, when carried out all within the one jurisdiction, or when a merchant computer carries out the invention and is programmed to operate with the remote system computer. Similarly, the invention is directed towards a host system computer programmed to operate with a remote merchant computer or indeed with a remote merchant financial institution computer. The term “remote”, in this specification, includes not only its normal meaning of physical remoteness, as would normally be always the situation within the one jurisdiction, but also remoteness in the sense that one or other of the computers or indeed they could all be in separate jurisdictions. It will also be appreciated that each of the computers will be provided with the necessary means to allow the invention to be carried out. Thus, for example, the invention provides a system in which the merchant computer has messaging means in order to be able to send out the transaction message and the various other messages and the financial institution will have some form of collection means to collect and process the system payment. Similarly, there will be various forms of crediting means and so on.

Further, the invention envisages that the invention can be carried out by a computer program comprising program instructions to perform any of the steps required by any of the various computers and terminals used to carry out the invention. Computer programs may also comprise the various means used and described herein. In most cases computers will be programmed to carry out the invention. Further, it is envisaged that these computer programs can be provided in many ways, such as on a record medium, they may be stored in a computer memory, they may be embodied in a read only memory or they may indeed even be carried on an electrical signal carrier, whether physically over wires or by wireless communications such as the internet.

The above is a very brief overview of the manner in which the invention works. It will be appreciated that, for example, as explained, when the customer has a separate account established with a customer financial institution, the funds will be transferred directly to the financial institution. Generally, to avoid unnecessary and expensive transfer of funds, funds will not be transferred from the host system computer until such time as the amount to be credited to the customer, either via the financial institution or by direct payment, exceeds a preset amount. Generally speaking, the funds will be sent, as stated already, either directly to the customer or via the customer's own financial institution on a predetermined triggering event occurring. Similarly, the predetermined triggering event might simply cause a statement of the funds credited to the customer in his or her customer systems account. This predetermined triggering event could be, for example, one or more of the amount credited to the customer system account exceeding a preset level, a preset time that has elapsed since the last time the necessary payment was made, the number of system payments exceeding a preset number or indeed, when the customer requests the necessary action.

It will be appreciated that in many instances, the amount being saved will be relatively small such as, for example, the change from a cash transaction or the deliberate payment by a customer through the merchant of a sum of money. Indeed, in some instances, the whole of the transaction with the merchant might in fact be a payment directly into the system.

Further, while it has been suggested above that the system computer would send regular statements of account to the customers, almost certainly, these would not be sent except when there is some triggering event such as, for example, time elapsed, the amount credited to the customer system or a credit being made to the customer, either directly by some form of cheque or draft or other payment, or through a financial institution, the effect of which would be to debit the customer's account. Again, obviously if a customer requires a statement, it can be sent.

One of the manners in which the present invention can be used, as mentioned above, is to provide a discount. Such a discount, for example, can be by way of a loyalty bonus operated by a particular merchant which can be totally controlled by the merchant or alternatively, may be a bonus or discount agreed with the operators of the system and users of the host system computer who then would be required to calculate the discount. In the latter case, then the merchant computer would request the system computer to confirm the discount as the system payment and the additional steps would be performed of the system computer calculating the discount, the discount being downloaded as a system payment to the merchant computer and then the merchant computer downloading the calculated system payment to the merchant financial institution. Again, it will be appreciated that there will be many ways of calculating the discount such as the time of day the transaction occurs, the day of the week the transaction occurs, the total monetary value of the transaction and indeed, the aggregate amount of the current and other transactions carried out within a predetermined time period prior to the current transaction. There could also be discounts, for example, for particular months and so on.

It will be appreciated that the present invention could operate on its own, simply standalone system, but equally well could be combined with any cheque card, debit card or any card which directly transfers funds, at least within a relatively small time span, between a merchant carrying out the transaction and the financial institution operating the card on behalf of the customer paying.

Essentially, when the savings card, according to the invention, is used, the card number and merchant details are captured as a new file. This new file can be linked to previous sales transaction. Subsequently, after the terminal details have been batched and sent to the card centre as is usual, the amount of money allocated following the sale transaction for the merchant is calculated from the set-up details. Also, as mentioned above, for example, the discounts can be changed, depending on the time of day, and so on.

It will be appreciated that essentially the system and method, according to the present invention, allows for the “mopping up”, as it were, of loose change and allows a very easy savings system. For example, customers can save a discount, they can be asked whether they want to save a percentage of the total spend, they could save the change, they could save any form of refunds, they could save a particular cash amount, and so on.

One of the great advantages of the present invention is that instead of the typical loyalty awards as are used in most trading situations which have to be provided by points, the present invention permits that the cash or monetary value of the loyalty amount be defined which can be subsequently saved by the customer.

Another of the great advantages of the present invention is that it will allow regular instalment saving as well as random saving and has a great advantage of being a point-of-sale saving so that people who know they are spending will be encouraged to also save.

The invention is not limited to the embodiments hereinbefore described but will be varied in both construction and detail within the scope of the claims.

1. A customer funds transfer method for use in a public communications network interconnecting a host system computer, including a central processor, a merchant database and a customer database, each merchant and customer having a unique ID stored in the respective databases; a merchant financial institution computer associated with a merchant computer for handling the merchants financial transaction with the customer; and a customer system account, associated with the host computer, for each customer, the method comprising, on a trade taking place between the merchant and the customer, the steps of:
the merchant computer sends a transaction message to the host system computer detailing an amount of money, namely, a system payment forming part or all of a financial transaction with the merchant by the customer which is to be credited to the customer, together with the merchant and customer IDs;
the merchant computer sends a similar message to the merchant financial institution computer;
the merchant financial institution collects the system payment and sends it to the host system computer; and
the host system computer credits the customer system account.

2. A method as claimed in claim 1, in which, when the customer has a separate account established with a customer financial institution and a predetermined triggering event occurs, the host system computer :
sends funds to the financial institution for the customer's separate account; and
debits the customer system account.

3. A method as claimed in claim 1, in which, when a predetermined triggering event occurs, the host system computer sends funds to the customer and debits the customer system account.

4. A method as claimed in claim 2, in which funds are not transferred to the customer until the amount credited to the customer system account exceeds a preset threshold.

5. A method as claimed in claim 1, in which the host system computer sends a message to the customer detailing the amount credited to the customer account on a triggering event occurring.

6. A method as claimed in claim 2, in which the predetermined triggering event comprises one or more of:
the amount credited to the customer system account exceeds a preset level;
a preset time has elapsed since the last time the necessary action, arising out of the triggering event, was carried out;
the number of system payments exceeds a preset number; and
the customer requests the necessary action.

7. A method as claimed in claim 1, in which the system payment comprises a discount to be determined by the host system computer and in which the system payment amount given in the transaction message is not a specific amount but requests the system computer to confirm the discount as the system payment, the additional steps are carried out of:
the system computer calculates the discount;
the discount is downloaded as a system payment to the merchant computer;
and the merchant computer downloads the calculated system payment to the merchant financial institution.

8. A method as claimed in claim 1, in which the system payment comprises a discount determined by the merchant computer.

9. A method as claimed in claim 7, in which the discount is determined by one or more of:
the time of day the transaction occurs;
the day of the week the transaction occurs;
the total monetary value of the transaction; and
the aggregate amount of the current and other transactions carried out within a predetermined time prior to the current transaction.

10. A customer funds transfer system for delivering funds to a customer system account from a merchant using a public communications network comprising:
a merchant computer;
a host system computer having a central processing unit (CPU), a merchant database storing a unique ID for the merchant computer, and a customer database storing a unique ID for each customer system account;
a merchant financial institution computer associated with a merchant computer for handling the merchant's financial transaction with the customer;
message means in the merchant computer to send a transaction message to the host system computer detailing an amount of money, namely, a system payment forming part or all of a financial transaction with the merchant by the customer which is to be credited to the customer, together with the merchant and customer IDs and to send a similar message to the merchant financial institution computer;
collection means in the merchant financial institution computer to collect the system payment and send it to the host system computer; and
credit means in the host system computer credit the customer system account with the system payment.

11. A system as claimed in claim 10, in which the host system computer has means to determine a triggering event and on the triggering event occurring, causing the funds in the customer system account to be transferred to a customer financial institution computer.

12. A host system computer programmed to operate in a public communications network interconnecting the host system computer, including a central processor, a merchant database, a customer database, each merchant and customer having a unique ID stored in the respective databases; a remote merchant financial institution computer associated with a remote merchant computer for handling the merchants financial transaction with the customer; and a customer system account, associated with the host computer, for each customer and to carry out a method comprising, on a trade taking place between the merchant and the customer, the method as claimed in claim 1, in conjunction with the remote merchant computer.

13. A merchant computer programmed to operate in a public communications network interconnecting a remote host system computer, including a central processor, a merchant database and a customer database, the merchant and customer having a unique ID stored in the respective databases; a remote merchant financial institution computer associated with the merchant computer for handling the merchants financial transaction with the customer;
and a customer system account, associated with the host computer, for each customer and to carry out a method comprising, on a trade taking place between the merchant and the customer, the method as claimed in claim 1, in conjunction with the remote systems computer.

14. A computer program comprising program instructions to perform the steps of claim 1.

15. A computer program comprising program instructions to perform the steps carried out by the merchant computer of claim 1.

16. A computer program comprising program instructions to perform the steps carried out by the system computer of claim 1.

17. A computer program as claimed in claim 14, when embodied on a record medium.

18. A computer program as claimed in claim 17, when stored in a computer memory.

19. A computer program as claimed in claim 17, when embodied in a read-only memory.

20. A computer program as claimed in claim 17, when carried on an electrical carrier signal.
